(19) United States
(12) Patent Application Publication
(10) Pub. No.: US 2014/0330577 A1
(43) Pub. Date: Nov. 6, 2014

(54) Apparatus And Method For A Post-Treatment Patient Compliance System

(71) Applicant: MouthWatch, LLC, New York, NY (US)

(72) Inventors: Brant Herman, Metuchen, NJ (US); Jerome Herman, New York, NY (US); Robert Bellhouse, New York, NY (US)

(73) Assignee: MouthWatch, LLC, New York, NY (US)

(21) Appl. No.: 14/270,355

(22) Filed: May 5, 2014

Related U.S. Application Data
(60) Provisional application No. 61/820,137, filed on May 6, 2013.

(51) Int. Cl. G06F 19/00

(52) U.S. Cl. CPC G06F 19/3418
USPC 705/2

(57) ABSTRACT

A system and corresponding method for post-treatment patient compliance for a medical patient is performed by a system having a memory operable to retain a series of instructions, and a processor operable to retrieve and execute the instructions to perform a series of steps. One step includes receiving as a first input any one of: information from a patient management system regarding the patient; information from a patient interview conducted with the patient; and information from one or more manual inputs. A patient treatment plan is generated based on the first input. As a second input, any one of: a drug interaction based information; an evidence-based clinical decision information; and a custom clinical input information, are received. Also, a third input of a treatment recommendation process is received. A comparison based on any two of the above first, second and third inputs is performed. A post-treatment recommendation specific to the patient is determined for the patient based on the comparison. The post-treatment patient compliance is effected via a patient notification process.

### BACKGROUND OF THE INVENTION

1. Field of the Invention

The present application relates generally to healthcare and more particularly to patient aftercare and compliance.

2. Related Art

There currently exists a major problem with patient aftercare and compliance. This is particularly true following treatment or surgery. It applies to the medical field as well as the dental field.

Patients are typically provided verbal or written instructions for aftercare following their treatment. However, these care instructions are provided to patients during a difficult time, following treatment. The treatment may be a traumatic event such as surgery. Here, the patient's attention and retention of instructions is often compromised.

A particular challenge is that there are limited tools available to monitor the patient. In particular, the ability to track and monitor the patient's adherence to the instructions and recommendations made following the treatment is desirable.

The end result of the current manner in which post-treatment patient compliance is administered is the potential for a wide range of health complications, and even death. Many of these complications could be prevented if there were an improved system for post-treatment compliance.

In particular, what is needed is a method, and corresponding apparatus, for providing, tracking and/or reminding patients of the details of an effective aftercare program. The benefits of this type of system would reduce such complications. They would also save tremendous amounts of money for the parties involved, including patients, clinicians and insurers. The greatest overall benefit would be the moral imperative of improving patient care for individuals.

### SUMMARY OF THE INVENTION

In exemplary embodiments, a method for effecting a post-treatment compliance for a medical patient is provided. The method may be performed by a system that includes: a memory operable to retain a series of instructions; and a processor operable to retrieve and execute the instructions to perform a series of steps.

The steps include: receiving as a first input any one of: information from a patient management system regarding the patient; information from a patient interview conducted with the patient; and information from one or more manual inputs; generating a patient treatment plan based on the first input; receiving as a second input any one of: a drug interaction based information; an evidence-based clinical decision information; and a custom clinical input information; receiving as a third input a treatment recommendation process; comparing the inputs of any two or more of the first input, the second input and the second input; determining a post-treatment recommendation specific to the patient for the patient based on the comparison; and effecting the post-treatment patient compliance via a patient notification process.

In an exemplary embodiment, the effecting step includes: providing as an output to the patient the post-treatment recommendation; and monitoring via inputs from the patient whether the patient is in compliance with the post-treatment recommendation. The effecting step may further include: notifying a clinician whether the patient is in compliance with the post-treatment recommendation.

In an exemplary embodiment, the patient treatment plan employs a standardized treatment code.

In an exemplary embodiment, the above determination includes information input from an external source. The external source may include any one of: an intraoral camera; a Bluetooth™ toothbrush; a pedometer; a food journal; and a blood pressure monitor.

In an exemplary embodiment, the patient treatment plan is based on a synthesized clinician information which is based on any one of: input about the patient retrieved from one or more telehealth tools; responses of the patient to one or more questionnaires; and responses of the patient provided by the patient upon one or more in-office visits.

In an exemplary embodiment, the determination is additionally based on a professionally rendered treatment recommendation.

In exemplary embodiments, a system is provided for effecting a post-treatment compliance for a medical patient. The system includes a memory operable to retain a series of instructions, and a processor operable to retrieve and execute the instructions to perform a series of steps.

The steps may be performed by certain means, including: a means for receiving as a first input any one of: information from a patient management system regarding the patient; information from a patient interview conducted with the patient; and information from one or more manual inputs; a means for generating a patient treatment plan based on the first input; a means for receiving as a second input any one of: a drug interaction based information; an evidence-based clinical decision information; and a custom clinical input information; a means for receiving as a third input a treatment recommendation process; and comparing the inputs of any two or more of the first input, the second input and the second input; a means for determining a post-treatment recommendation specific to the patient for the patient based on the comparison; and a means for effecting the post-treatment patient compliance via a patient notification process.

In an exemplary embodiment, the above effecting means includes: a means for providing as an output to the patient the post-treatment recommendation; and a means for monitoring via inputs from the patient whether the patient is in compliance with the post-treatment recommendation. The effecting means may further include: a means for notifying a clinician whether the patient is in compliance with the post-treatment recommendation.

In an exemplary embodiment, the patient treatment plan may employ a standardized treatment code.

In an exemplary embodiment, the determination may include information input from an external source. The external source may include any one of: an intraoral camera; a Bluetooth™ toothbrush; a pedometer; a food journal; and a blood pressure monitor.

In an exemplary embodiment, the patient treatment plan is based on synthesized clinician information being based on any one of: input about the patient retrieved from one or more telehealth tools; responses of the patient to one or more questionnaires; and responses of the patient provided by the patient upon one or more in-office visits.

In an exemplary embodiment, the determination may be additionally based on a professionally rendered treatment recommendation.

Further features and advantages of the invention, as well as the structure and operation of various exemplary embodiments of the invention, are described in detail below with reference to the accompanying drawings.

### BRIEF DESCRIPTION OF THE DRAWINGS

The foregoing and other features and advantages of the invention will be apparent from the following, more particular description of various exemplary embodiments including a preferred embodiment of the invention, as illustrated in the accompanying drawings wherein like reference numbers generally indicate identical, functionally similar, and/or structurally similar elements. The left most digits in the corresponding reference number indicate the drawing in which an element first appears.

FIG. 1 is a block diagram illustrating system for post-treatment compliance according to certain embodiments.

FIG. 2 is a block diagram illustrating a series of modules and their respective inputs and outputs for implementing certain embodiments.

FIG. 3A is a block diagram illustrating the components of a patient generated health information module 300.

FIG. 3B is a flow chart illustrating certain steps related to the function of a patient diagnostic tools sub-module.

FIGS. 3C and 3D are flow charts illustrating certain steps performed by a patient diagnostic questionnaire sub-module.

FIG. 4 is a flow chart illustrating certain steps performed by a treatment determination module.

FIG. 5 is a flow chart illustrating certain steps performed by a patient decision module.

FIG. 6 is a flow chart illustrating certain steps performed by an analysis module.

FIG. 7 is a flow chart illustrating certain steps performed by a treatment recommendation process module.

FIG. 8 is a flow chart illustrating certain steps performed by a preferred notification module.

FIG. 9 is a flow chart illustrating certain steps performed by a component of the preferred notification module.

FIG. 10 depicts an exemplary illustration of an intra-oral camera being optionally fitted with a plurality of UV LEDs in accordance with certain embodiments.

FIG. 11 depicts shows an exemplary flow chart of an exemplary embodiment using a smart phone application.

FIG. 12 depicts an exemplary embodiment wherein a patient and dental practitioner collaborate in real time.

### DETAILED DESCRIPTION OF VARIOUS EXEMPLARY EMBODIMENTS OF THE PRESENT INVENTION

### Exemplary Embodiments

While specific exemplary examples, environments and embodiments are discussed below, it should be understood that this is done for illustration purposes only. A person skilled in the relevant art will recognize that other components and configurations can be used without parting from the spirit and scope of the embodiments. In fact, after reading the following description, it will become apparent to a person skilled in the relevant art how to implement the invention in alternative examples, environments and embodiments.

The present embodiments are described in relation to a system and method for a post-treatment compliance system as used in the health care industry. However, the characteristics and parameters pertaining to the system and method may be applicable to a compliance system and corresponding methods that may be used in other industries.

An Exemplary Post-Treatment Compliance System

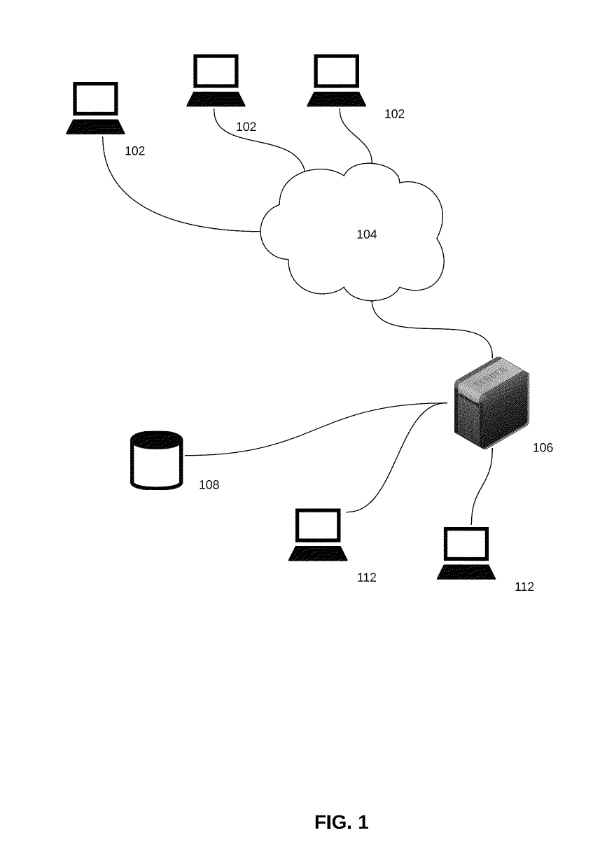

FIG. 1 illustrates one embodiment of a system 100 for post-treatment compliance according to the present embodiments.

Client Stations

As shown, the system 100 may include a plurality of client stations 102 that may be accessed by users of system 100. The users may be, for example, patients, but may also be any other entities, such as providers, payers, networks, laboratories and the like. Where the present embodiments are employed in the context of healthcare, in addition to the patients, the users may be health care clinicians, providers and payers, such as insurance companies. A patient, or a clinician, for example, may access stations 102 to enter or retrieve information process by the server 106.

Collectively, users of stations 102 may be referred to as clients of system 100. Other clients are possible. In one embodiment, a client stations 102 may be portable to provide maximum accessibility to the system 100.

Client stations 102 may include any known processing engines, whether resident or remotely accessible, and run any known applications. Examples include a personal or laptop computer, or a tablet, running an operating system (for example, a Microsoft Windows™ 98 operating system, a PalmOS™ operating system, a Unix™ operating system, a Linux™ operating system, a Solaris™ operating system, an OS/2™ operating system, a BeOS™ operating system, a MacOS™ operating system, a VAX VMS operating system, or other operating system), or related platform.

Client stations 102 may include any known processing systems (for example, a microprocessor such as an Intel x86-based or Advanced Micro Devices x86-compatible device, a Motorola 68K or PowerPC™ device, a MIPS device, Hewlett-Packard Precision™ device, or a Digital Equipment Corp. Alpha™ RISC processor, a microcontroller or other general or special purpose device operating under programmed control).

Client stations 102 may further include any known memory system. Exemplary memory systems include an electronic memory such as a random access memory (RAM) or electronically programmable read only memory (EPROM), a storage such as a hard drive, a CDROM or a rewritable CDROM or another magnetic, optical or other media, and other associated components connected over an electronic bus, as will be appreciated by persons skilled in the art.

Client stations 102 may be equipped with any known integral or connectable display system. Exemplary display systems include a cathode ray tube (CRT), a liquid crystal display (LCD), electroluminescent display, a light emitting diode (LED) or another display screen, panel or device for viewing and manipulating files, data and other resources, for instance using a graphical user interface (GUI) or a command line interface (CLI).

Client stations 102 may also include any network-enabled appliance. Exemplary network-enabled appliances include a WebTV™ unit, a radio-enabled Palm™ Pilot or similar unit, a set-top box, a networkable game-playing console such as a Sony™ Playstation™, Sega™ Dreamcast™ or a Microsoft™ XBox™ a browser-equipped or other network-enabled cellular telephone, or another TCP/IP client or other device.

Communications Link

As shown in FIG. 1, client stations 102 are connected to a communications link (or network) 104. Any known communications links/networks may be used. For example, the communications link 104 may be, include or interface to any one or more of, for instance, the Internet, an intranet, a Personal Area Network (PAN), a Local Area Network (LAN), a Wide Area Network (WAN) or a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, V.34 or V.34bis analog modem connection, a cable modem, an Asynchronous Transfer Mode (ATM) connection, or a Fiber Distributed Data Interface (FDDI) or Copper Distributed Data Interface (CDDI) connection.

The communications link 104 may further include or interface to any one or more devices over, or in concert with, any known protocols. Exemplary types of links include a Wireless Application Protocol (WAP) link, a General Packet Radio Service (GPRS) link, a Global System for Mobile Communication (GSM) link, a Code Division Multiple Access (CDMA) or Time Division Multiple Access (TDMA) link such as a cellular phone channel, a Global Positioning System (GPS) link, cellular digital packet data (CDPD), a Research in Motion, Limited (RIM) duplex paging type device, a Bluetooth, BlueTeeth or WhiteTooth radio link, or an IEEE 802.11 (Wi-Fi)-based radio frequency link. The communications link 104 may further include or interface to any one or more of an RS-232 serial connection, an IEEE-1394 (Firewire) connection, a Fibre Channel connection, an infrared (IrDA) port, a Small Computer Systems Interface (SCSI) connection, a Universal Serial Bus (USB) connection or another wired or wireless, digital or analog interface or connection.

Server Station and External Storage Database

Also connected to the communications link 104, and thereby accessible to departments or units using client stations 102, is a server station 106. While illustrated as a resident device, in actuality its physical location and processing capability may be performed over remote links, in a cloud architecture, and employing any known technologies. Additional client stations 112 may also be directly coupled to the server station 106. External storage database 108 may also be coupled with the server station 106 (as well as with client stations 102, 112) for storage and retrieval of information externally from the stations.

A user may access the server station 106 via the communications link 104 using client station 102 or 112. Specifically, a user, for example a clinician, using system 100 may input, add, remove, and edit data or information, and/or enhance system functionality, for example, using an input device to station 102. Identification of a user using station 102 may be determined automatically by the system 100 in multiple manners, such as for example identifying the IP address of the client station 100, over an Internet connection, or the LAN address of the client station 100, over a LAN connection. Other information, including security and identification information, may be included as well.

In an exemplary embodiment, information relied on by the system 100 may be stored in database 108, which may provide external storage. The database 108 may include or interface to, for example, an Oracle™ relational database sold commercially by Oracle Corporation. Other databases, such as an Informix™ database, Database 2 (DB2) database, a Sybase™ database or another data storage or query format, platform or resource such as an On Line Analytical Processing (OLAP) data storage facility, a Standard Query Language (SQL) data storage facility, a storage area network (SAN) facility, or a Microsoft Access™ database or other similar database platform or resource. The database 108 may be supported by a server or other resources, and may include redundancy, such as a redundant array of independent disks (RAID), for data protection SAN. For example, the database 108 and the server station 130 may comprise an OLAP system that generates a plurality of user-specific reports from data maintained by the database 108. In another example, the server station 106 may be associated with or connected to a database server (not shown) that serves to present queries against the database 108. The database server may comprise an OLAP server system for accessing and managing data stored in the database 108. The database server may also comprise a Relational On Line Analytical Processing (ROLAP) engine, a Multi-dimensional On Line Analytical Processing (MOLAP) engine, or a Hybrid On Line Analytical Processing (HOLAP) engine according to different embodiments. Specifically, the database server may comprise a multithreaded server for performing analyses directly against the database 108.

In an exemplary embodiment, server station may 106 comprises a single server or engine (as shown). In another embodiment, server station 106 comprises a plurality of servers or engines, dedicated or otherwise, which further host modules (further described below) for performing desired system functionality.

Overview of Post-Treatment Compliance

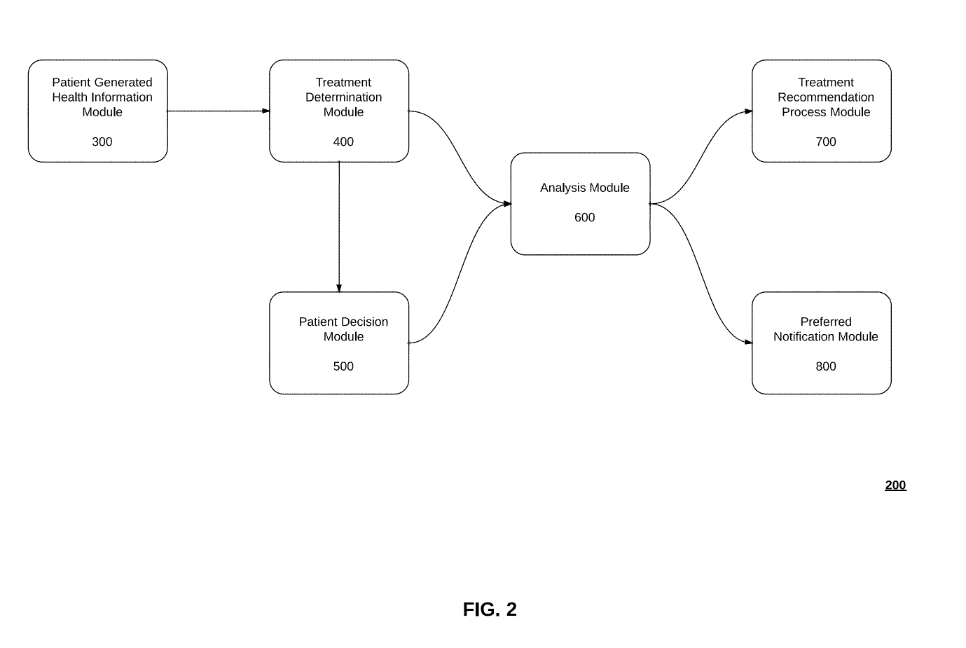

The server station 106 may host one or more applications or modules that function to permit interaction between the users, as it relates to the core and/or ancillary functions of the post-treatment compliance system 100. In exemplary embodiments certain modules 300-800 (refer to FIG. 2 below) making up a post-treatment compliance system 200 (refer to FIG. 2 below) run on or in concert with server 106. In certain embodiments, an improved means is provided by which clinicians can provide any one or more functions.

Server station 106 can include one or more post-treatment compliance modules 300-800 that permit interaction between system 100 and users accessing clients 102 or 112. An exemplary server 106, itself, may include, function or interact with workstations that include, function or interact with any of the above processing engines, processing systems, operating systems, memory systems, displays and/or communications link, as well as any others.

Use by Clinicians and Patients

By way of example only, and not by way of limitation, clinicians employing clients 102 and/or 112, working with patients employing clients 102 and/or 112, may: (a) obtain and consider a patient's medical history when determining a course of treatment and post-treatment care recommendations; (b) obtain and consider a patient's allergies and current medications to determine potential drug interactions based upon medications prescribed following treatment; (c) consult with sources of expert knowledge, including clinical reference databases when determining a course of treatment and plan for post treatment care; (d) have structured interaction with other clinicians in the collaborative determination of treatment and post-treatment recommendations, and for collaborative monitoring; (e) provide an interactive, auditable and secure means by which clinicians and their patients can communicate interactively during the post-treatment intervals between office visits for the purpose of improving patient compliance with post-treatment recommendations, and improving the scheduling of follow-up office visits.

### Exemplary Features and Functions of Post-Treatment Compliance

In exemplary embodiments the exemplary post-treatment patient compliance system 200 running on server 106 additional features and functions, including by way of example only, that one or more of the steps being performed by the modules: (a) are recorded in a secured format, including for example, a secure auditable history (log) file; (b) satisfy compliance standards, including for example HIPAA (“Health Insurance Portability and Accountability Act”) compliance in the application of best care practices pre- and post-treatment, including: (1) automated, auditable logs of certain steps in obtaining and reviewing patient medical history, treatment determination and post-treatment care compliance; (2) cross-referencing of patient history and potential drug interactions between current patient medications and medications that may be prescribed pre- and post-treatment; (3) structured and documented collaboration between remotely-located medical professionals; and (4) proactive patient engagement in post-treatment care between office visits, including remote visual observation by the clinician of the patient's healing process.

These and other features and advantages of the present embodiments are set forth more specifically below. While the application of the exemplary embodiments is described in reference to dental professionals and patients, this is not to have limiting effect of the present embodiments to dental care specifically or health care in general, as the applications widely expand beyond these areas.

Overview of Post-Treatment Compliance System Components

In exemplary embodiments, the need to more effectively implement standards of care tailored to a patient's specific health history and risk factors is addressed. Whereas typically, clinicians rely on a patient's written and verbal recollection of health history and current medications, In exemplary embodiments however, the executed system provides: (1) the ability to access accurate and timely patient medical information via electronic health records (EHR); (2) The ability to obtain relevant information from the patients prior to medical consultations, in the form of patient questionnaires or data from medical monitoring devices; (3) require patient confirmation of the correctness of their medical information; (4) provide efficient and documented consultation with sources of expert knowledge regarding treatment and post-treatment care; and (5) provide collaboration with other healthcare professionals regarding the case at hand.

In an exemplary embodiment, the post-treatment compliance system 200 executing on server 106 provides a means by which clinicians: (1) access patient medical information via electronic health records (EHR); (2) alert clinicians to possible drug interactions between medications which may be prescribed and drugs currently being taken by the patient under another doctor's instructions; (3) incorporate additional patient-provided information from questionnaires and data from telehealth devices; (4) refer to sources of expert clinical knowledge; and (5) refer to other healthcare professionals/specialists regarding treatment plans in consideration of a patient's specific and overall health situation.

The post-treatment compliance system also provides a means for patient-specific post-treatment care planning. This raises the standard of care for clinicians when determining a course of post-treatment care for a given patient. Monitoring compliance of the post-treatment care also raises the standard of care. While in prior art systems, certain post-treatment care recommendations have generally been determined individually by each clinician, after referencing the most recent clinical research and recommendations, in certain embodiments the post-treatment compliance system 200 running on server 106 provides for an improved approach for the development of post-treatment care recommendations. Examples include a means by which post-treatment care recommendations are developed through a computer-based expert systems approach, using a range of patient information, clinically advised care recommendations, clinical decision making tools, along with other factors, and predefined algorithms based the patient's information, rules based on expert knowledge and drug interaction tables.

In an exemplary embodiment, post-treatment compliance system 200 provides patient-specific engagement in the implementation and monitoring of post-treatment care. Patients and clinicians are enabled to communicate in a timely, accurate and effective way during the post-treatment interval between office visits, in particular, so that clinicians can ensure compliance with the recommendations they have given a patient. As an example, in certain dental procedures, following a tooth extraction or periodontal surgery, patients are advised regarding foods and beverages, oral hygiene, medications, awareness of contraindications. A structured approach is provided such that post-treatment recommendations of clinicians, including verbal instructions, written documentation, emails, texts and telephone calls, are monitored. The patient is also proactively engaged by the system in accepting, performing or reporting on his or her adherence to post-treatment care recommendations.

Accordingly, the post-treatment system 200 provides a number of improvements in relation to the standards of care. First, the patient benefits since, through improved determination of treatment and of post treatment compliance activities, he or she is more likely to have a successful treatment result and is less likely to have complications. Second, the clinician benefits since the risk of patient complaints, incomplete healing or malpractice claims based on an unsatisfactory outcome are reduced.

Implementation by Modules

As described in reference to the present embodiments, modules refers to certain functional units capable of performing one or more tasks. In one or more exemplary embodiments, these modules are implemented in hardware, software, or a combination of hardware and software. For example, an exemplary module 102-118 can be implemented as a hardware circuit comprising custom VLSI circuits or gate arrays, off-the-shelf semiconductors such as logic chips, transistors, or other components. A module may also be implemented in programmable hardware devices such as field programmable gate arrays, programmable array logic, programmable logic devices or the like.

Modules may also be implemented using software, which is then stored on a storage device for execution by various types of processors. A storage device can take any form capable of storing machine-readable instructions on a digital processing apparatus. Examples of a computer readable storage medium include, but are not limited to, a semiconductor or solid state memory, magnetic tape, a removable computer diskette, a random access memory (RAM), a read only memory (ROM), a Bernoulli drive, ARDUINO, a magnetic disk, flash memory, integrated circuits, or other digital processing apparatus memory device, and an optical disk. Current examples of optical disks include a compact disk with read only memory (CD-ROM), a compact disk with read/write (CD-R/W), and a digital video disk (DVD).

In an exemplary embodiment, an identified module of executable code can comprise one or more physical or logical blocks of computer instructions which can be organized as an object, procedure, or function.

A module of executable code can be a single or a plurality of instructions, and, in a certain exemplary embodiment, can even be distributed over several different code segments, among different programs, across several storage or memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more physical devices which are referred to herein as computer readable media and/or electronic data storage devices.

In certain exemplary embodiments, processor module 104 is a processing device as defined hereinbelow. In an exemplary embodiment, processor module 104 is a central processing unit (CPU), comprising certain combinations of hardware and/or software within sprinkler management system 100 that carries out the instructions of a computer program, either resident in sprinkler management system 100 or obtained from an input to the device, by performing certain arithmetical, logical, and input/output operations. In an exemplary embodiment, processor module 104 includes an arithmetic logic unit (ALU), which performs arithmetic and logical operations, and a control unit (CU), which extracts instructions from memory and decodes and executes them, calling on the ALU when necessary. In certain exemplary embodiments, processor module 104 works in concert with the other modules of sprinkler management system 100 to permit the function of the modules.

In certain exemplary embodiments, memory module 102 is an internal (or a primary) memory, and can also include an external (or secondary) memory as defined hereinbelow. In an exemplary embodiment, memory module 102 can be directly accessible to the processor module 104. The processor module 104 reads instructions stored in the memory module 102 and executes them as required. In an exemplary embodiment, an internal (primary) memory can be a random access memory (RAM). An external (secondary) memory can include, but not limited to, a removable memory chip, a hard disk drive, a removable storage drive, representing a floppy disk drive, a magnetic tape drive, an optical disk drive, etc. In alternative embodiments, an external (secondary) memory can include other similar means for allowing computer programs or other instructions to be read by processor module 104.

Post-Treatment Compliance Components

FIG. 2 provides a block diagram illustrating the various modules of the post-treatment compliance system 200 according to certain embodiments. In particular, FIG. 2 includes patient generated health information module 300, treatment determination module 400, patient decision module 500, analysis module 600, treatment recommendation process module, and preferred notification module 800.

As illustrated in FIG. 2, there are a series of inputs and outputs as between the above noted modules in certain exemplary embodiments. The patient generated health information module 300 provides an output to treatment determination module 400. Patient decision module 500 receives as input the output from treatment determination module 400. Analysis module 600 receives as input the output from treatment determination module 400 as well the output from patient decision module 500. In response to the above noted inputs, the analysis module 600 provides outputs to treatment recommendation process module 700 and preferred notification module 800. The specific structural and functional limitations of the foregoing modules, for certain exemplary embodiments, is further described below.

Patient Generated Health Information Module

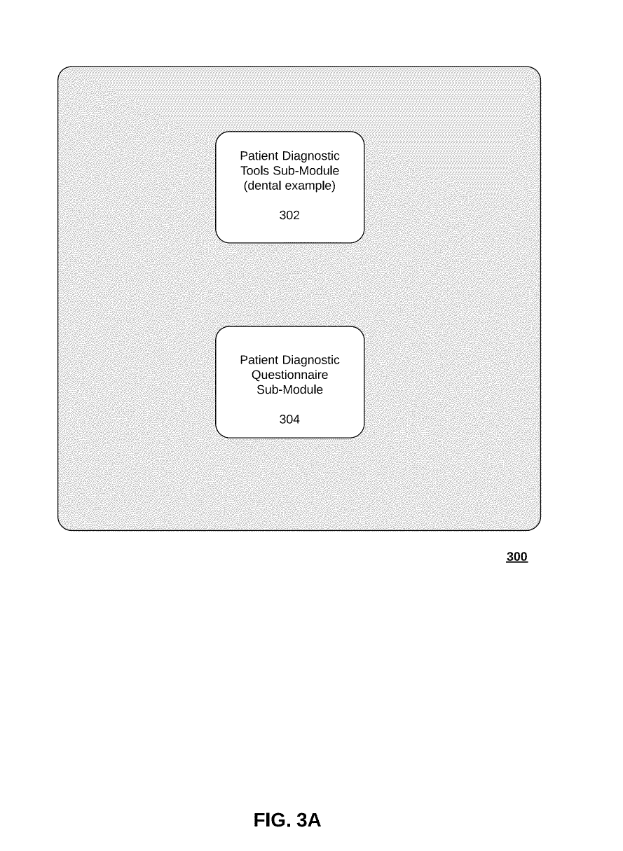

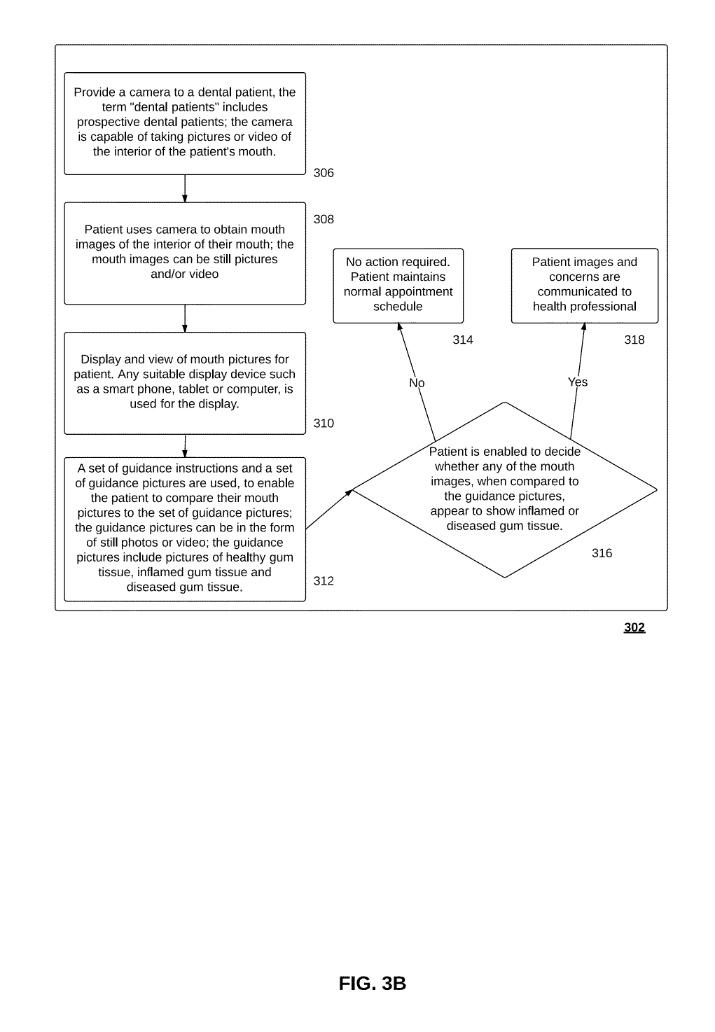

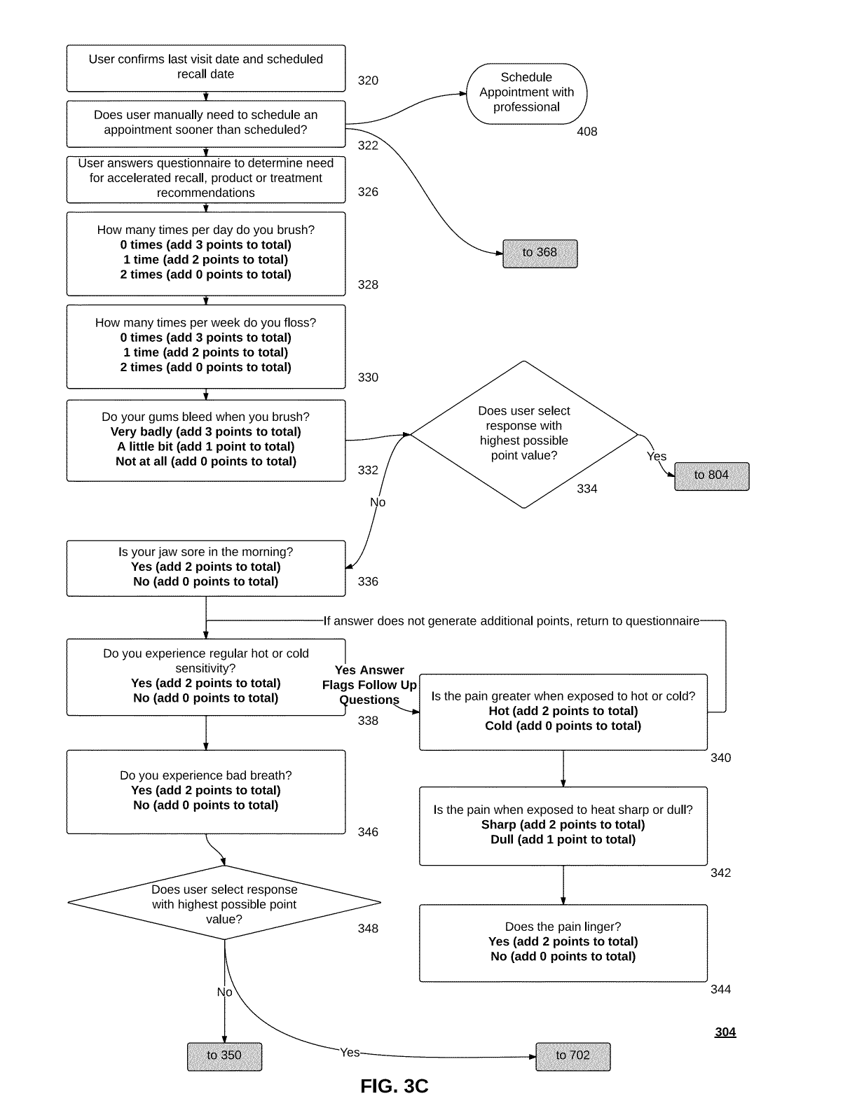

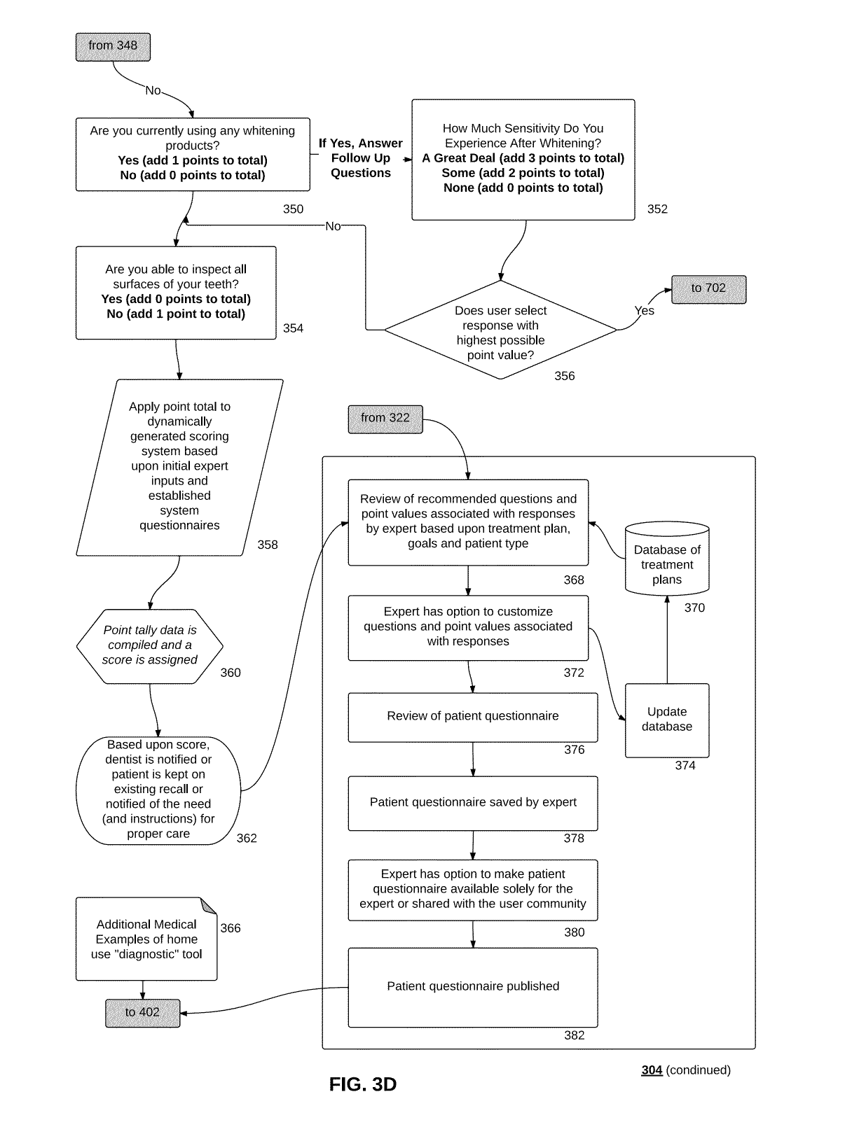

The patient generated health information module 300 is further illustrated in FIG. 3A. As shown therein, patient generated health information module 300 includes patient diagnostic tools sub-module 302 and patient diagnostic questionnaire sub-module 304. As shown, the patient diagnostic tools is described in certain exemplary embodiments with respect to treatment in the dental arts.

In turn, FIG. 3B illustrate an exemplary implementation of the function of patient diagnostic tools sub-module 302 in greater detail. As recognized by skilled persons, the patient diagnostic tools sub-module 302 provides a series of inputs and outputs to be received between processors of server 106 and a user, such as a patient.

Beginning with step 306, the camera is provided to a dental patient, in the exemplary embodiment. The term dental patient may include prospective dental patients as well as existing patients. In an exemplary embodiment, the camera is capable of taking pictures or videos of the interior of the mouth of the patient.

Next, in step 308, the patient uses the camera to obtain images of the mouth, specifically of the interior of the mouth. The mouth images can be still pictures or video.

Control then passes to step 310, where the mouth pictures or video images are displayed for the patient, who can view them, using any suitable display device, such as for example a smart phone, a tablet, or any type of processing computer.

Next, control passes to step 312. In step 312, the patient uses a set of guidance instructions and a set of guidance pictures. In particular, the system permits the patient to compare his or her mouth pictures and or video to the set of guidance pictures and/or videos. The guidance pictures and/or videos include images of healthy gum tissue, as well as inflamed or diseased gum tissue.

In step 316, the system enables the patient to decide whether any of the above mouth images, when compared to the guidance pictures, appear to show an inflammation or disease of the gum tissue.

If the response to step 316 the response is yes, the patient's images, and concerns, become communicated to a health professional.

On the other hand, if the response to set 316 is no, no further action is required. The patient can maintain a normal appointment schedule.

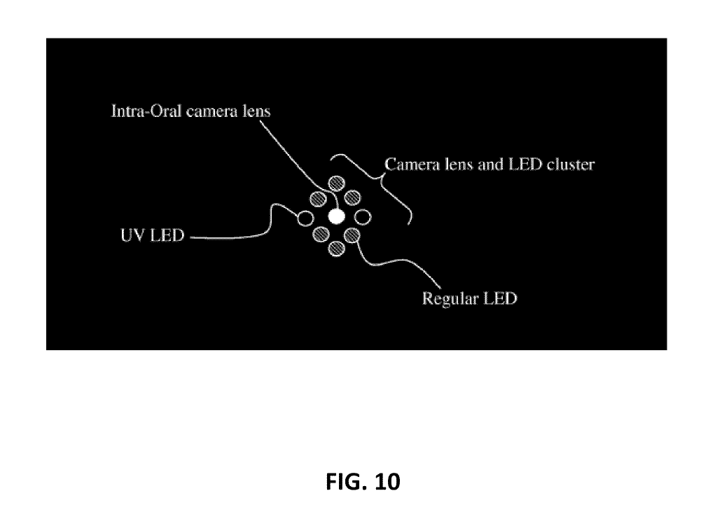

Turning to FIGS. 3C and 3D, these figures illustrate an exemplary implementation of the function of patient diagnostic questionnaire sub-module 304 in greater detail. Furthermore, one or more embodiments directed to systems, devices and relevant methods used in relation to FIGS. 3C and 3D are described below in reference to FIGS. 10-12.

Beginning with FIG. 3C, in step 320, the user confirms the last visitation date with the health-care provider, as well as the scheduled recall date. Controlled thereafter flows to step 322.

In step 322, it is determined whether the user needs to manually schedule an appointment sooner than the above date. If the response is in the affirmative, control passes to step 408. In addition, control may also be passed to step 368, as described below.

In step 326, the user answers certain questionnaires. The questionnaire, as provided below, may be established for treatment recommendations. The questionnaire may also be established for other reasons, such as product recall for health-care products.

In exemplary embodiments, the questionnaire for treatment begins with step 328. In certain exemplary embodiments, points are assessed to determine the treatment recommendations, as shown for step 328. Specifically, in step 328, points are added based on the number of times that the user brushes his or her teeth per day. If the user brushes zero times, three points are added to the total number of points. On the other hand, if the user brushes one time per day, two points are added. Alternatively if the user brushes two times per day, zero points are added to the total. Control passes next step 330.

In step 330, module 300 solicits from the user the number of times that the user flosses per day. In the exemplary embodiment shown, if the user flosses zero times per day, three points are assessed, or if the user flosses one time per day, two points or assess, or alternatively if the user flosses two times per day, zero points are assessed.

In step 332, it is inquired whether the patient user's gums bleed upon brushing. If the user's response is that there is very bad bleeding, three points are assessed, whereas if the user responds that there is a little bit of bleeding, one point is assessed, and if there is no bleeding, zero points are assessed. Thereafter control passes to step 334.

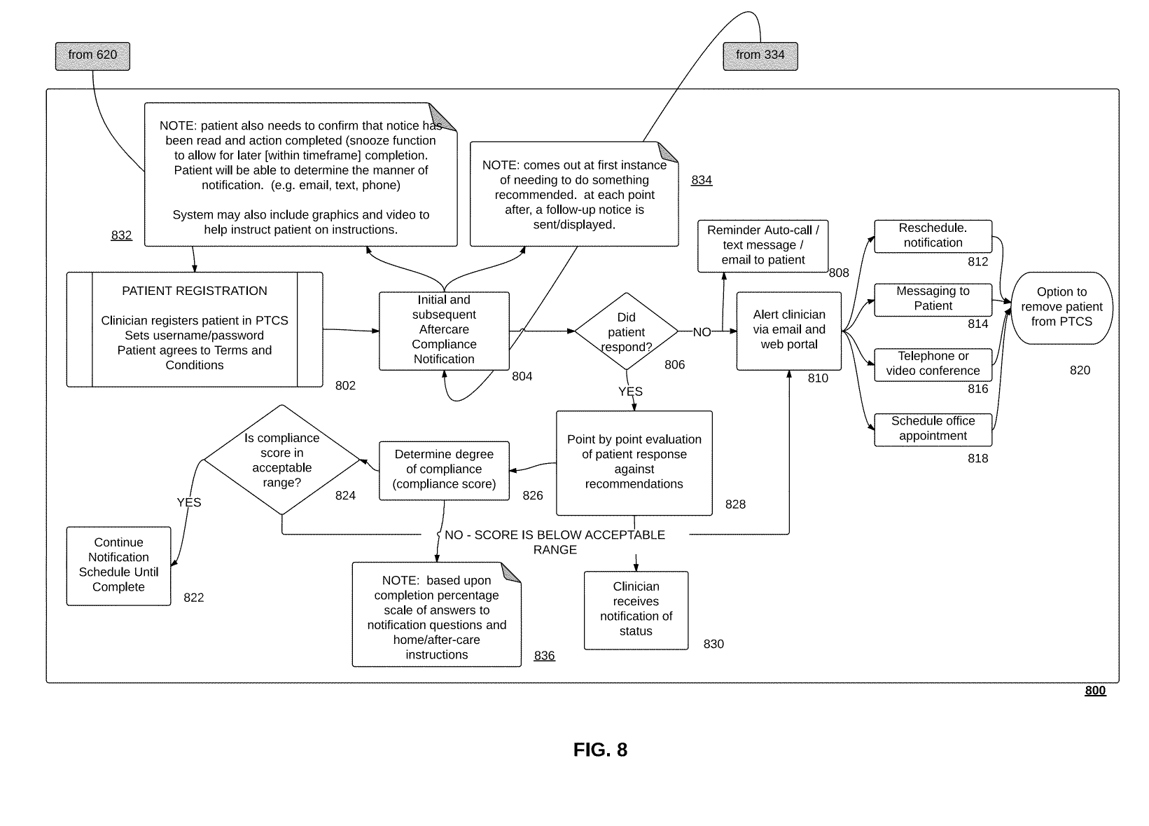

In step 334, in an exemplary embodiment it is inquired whether the user selects responses with the highest possible point values. If the answer is in the affirmative, control may be passed to step 804, as described in reference to FIG. 8. If not, control passes to set 336.

In step 336, it is determined whether the user's jaw is sore in the morning. If the answer is in the affirmative, two points are added to the total, whereas if the answer is in the negative, zero points are added to the total. Control passes thereafter to step 338.

If the response to step 336 is that no additional points are generated, then control passes may be passed to steps 340-344, for further assessment. In step 340, it is determined whether the pain is greater upon exposure to hot or cold, with an award of two points in the affirmative for hot and no points for cold. In step 342, it is determined whether the pain when exposed to heat is sharp or dull, with two points being assessed for sharp pain, and one point being assessed for dull pain. In step 344, it is determined whether the pain lingers, with two points being assessed for lingering pain, and no points being assessed for non-lingering pain.

Control passes thereafter from either step 338 or 344 to step 346, where it is determined whether the user experiences bad breath. If the answer is in the affirmative, two points are added to the total, whereas if the answer is in the negative, no points are added.

Following step 346, control passes to step 348, where it is determined whether the user has selected a response with the highest point value, where control may be passed to 702 if in the affirmative, or alternatively, control may be passed to the next step 350 if in the negative.

Step 350 is shown at the top of FIG. 3C. In step 350, it is determined whether the user is currently using any whitening products. If the response is in the affirmative, one point is assessed, but alternatively in the negative, zero points are assessed.

If the response to step 350 is in the affirmative, control passes to step 352. In step 352, it is determined how much sensitivity the user experiences after whitening. If the response is a great deal, three points are added to the total, but if the response is some sensitivity, two points are added to the total, and alternatively, if the response is no sensitivity, then zero points are added to the total. Control passes thereafter to step 356.

In step 356, it is determined whether the user has selected a response with highest possible point value, and if so, control may be passed to step 702, as described below. If not, then control passes to step 354.

In step 354, it is determined whether the user is able to inspect all of the surfaces of his or her teeth. If the response is yes, zero points are added to the total, but alternatively if the response is no, one point is added to the total.

Step 358 follows step 354, where a point total is applied to a dynamically generated scoring system. In an exemplary embodiment, this is based on initial expert inputs and/or established system questionnaires.

In step 360, a point tally of the data is compiled. A score other than the raw point total may be assigned as well. Control passes thereafter to step 362.

In step 362, certain determinations may be made and actions may be taken based upon the based on the. For example, the dentist may be notified, or the patient user may be kept on an existing recall list (if a dental product is being used), or there may be notification to the user of a need, including instructions, for proper care.

Following step 362, clinician customization of patient created health information 384 is next performed. Alternatively, control to 384 may have passed from step 322 as shown. In an exemplary embodiment, step 384 refers to a series of steps that may be performed by experts, such as clinicians, to customize the above health care information pertaining to the patient.

Beginning with step 368, a review is performed of the above recommended questions and point values that were associated with the responses by the expert. In an exemplary embodiment, this is based upon a treatment plan, the goals established and the type of patient.

In step 372, the expert has the option of customizing the questions as well as the point values that are associated. Following step 372, the database 374 may be updated accordingly, and in step 370, the database of treatment plans may be updated accordingly, to return control back to step 368 for re-assessment and/or repetition.

Next, in step 376 the patient questionnaire may be reviewed, and in step 378, may be saved by the expert. In step 380, the expert has the option to make the patient questionnaire available solely to him- or herself, or to other experts using the system, or instead to be shared with the community of users. Control passes thereafter to step 382, where the patient questionnaire is published.

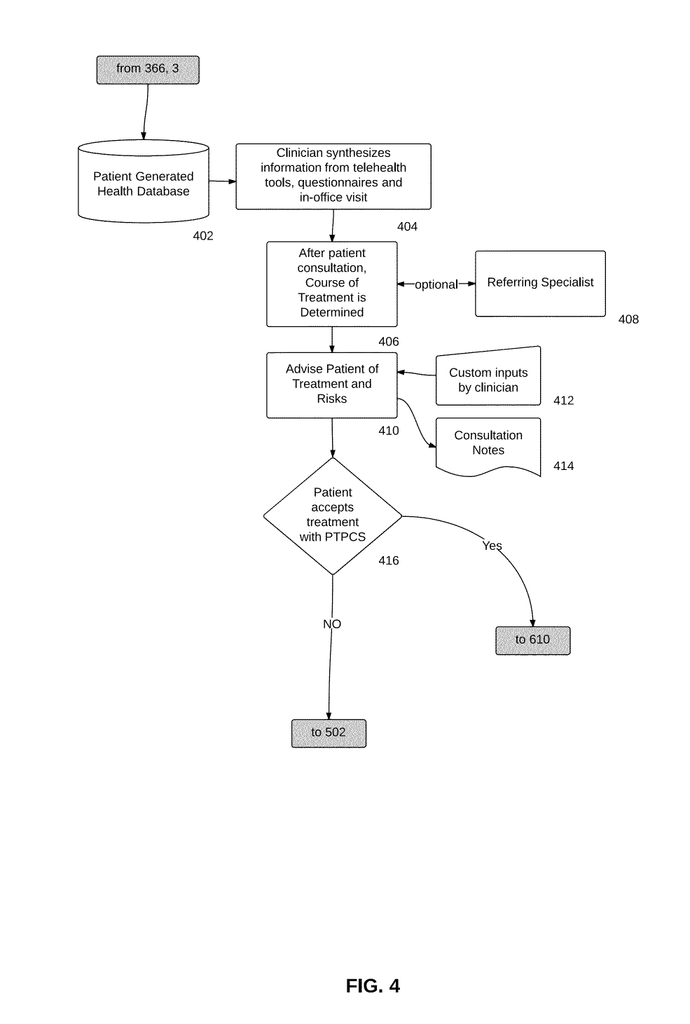

Following step 382, control passes to step 402, which is further described in reference to FIG. 4 below. In addition, as shown in step 366, additional medical examples, such as home use of diagnostic tools, may also be input to step 402.

Treatment Determination Module

FIG. 4 illustrates certain steps performed by treatment determination module 400. The module facilitates and documents steps involved in a) synthesizing information provided to the clinician from the patient prior to a medical examination (This information may be data from medical devices which are monitoring the patient and/or questionnaires.); b) determining a proposed treatment (The clinician may identify treatment plans including benefits, costs and risks based on the diagnosis.), c) communicating that recommendation to the patient (The clinician advises the patient of alternative treatment options, including benefits, costs and risks. These alternatives may be documented.), and d) facilitating patient decisions regarding the proposed treatment and post-treatment care plans (The patient is requested to make a decision regarding their preferred treatment plan. This decision may be documented.).

In determining a proposed treatment, the clinician may identify alternative treatment plans including benefits, costs and risks based on the diagnosis. A recommendation may also be communicated to the patient, where the clinician may advise the patient of alternative treatment options, including benefits, costs and risks. These alternatives may also be documented.

Treatment determination module 400 may also facilitate patient decisions regarding the proposed treatment and post-treatment care plans. This may include requesting the patient to make a decision regarding their preferred treatment plan. The decision may be document as well.

Returning to FIG. 4, beginning with step 402, control and inputs from the above steps 366 and 382 may be passed to the patient generated health database. Control passes control passes thereafter to step 404.

Instep 404, the processes alone, or in concert with the clinician, may synthesize information from such sources as telehealth tools, questionnaires or in-office visits having been made by the patient.

Next, in step 406, following the patient consultation, a course of treatment for the patient may be determined. Optionally, following step 406, a referral may be made to a specialist in step 408.

Following step 406, the patient may be advised of the treatment and the relevant risks involved. As illustrated, the clinician may provide consultation notes in step 414, and there maybe custom inputs by clinicians in step 412.

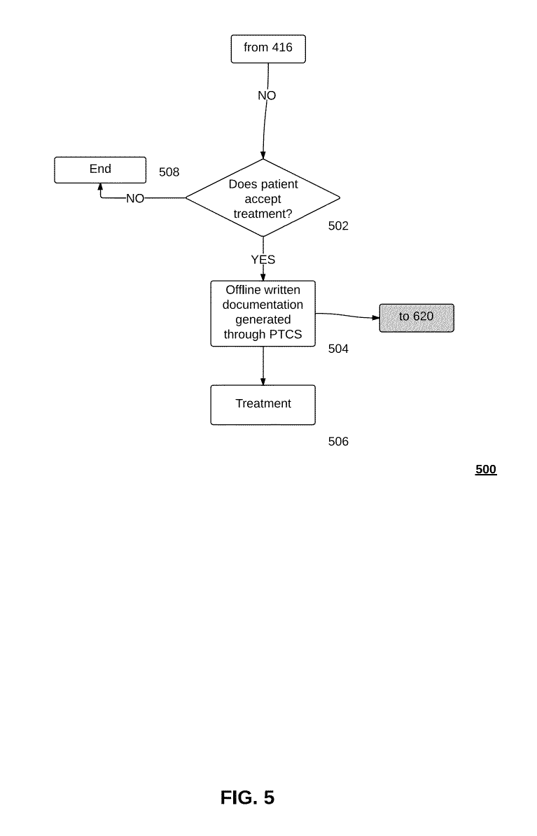

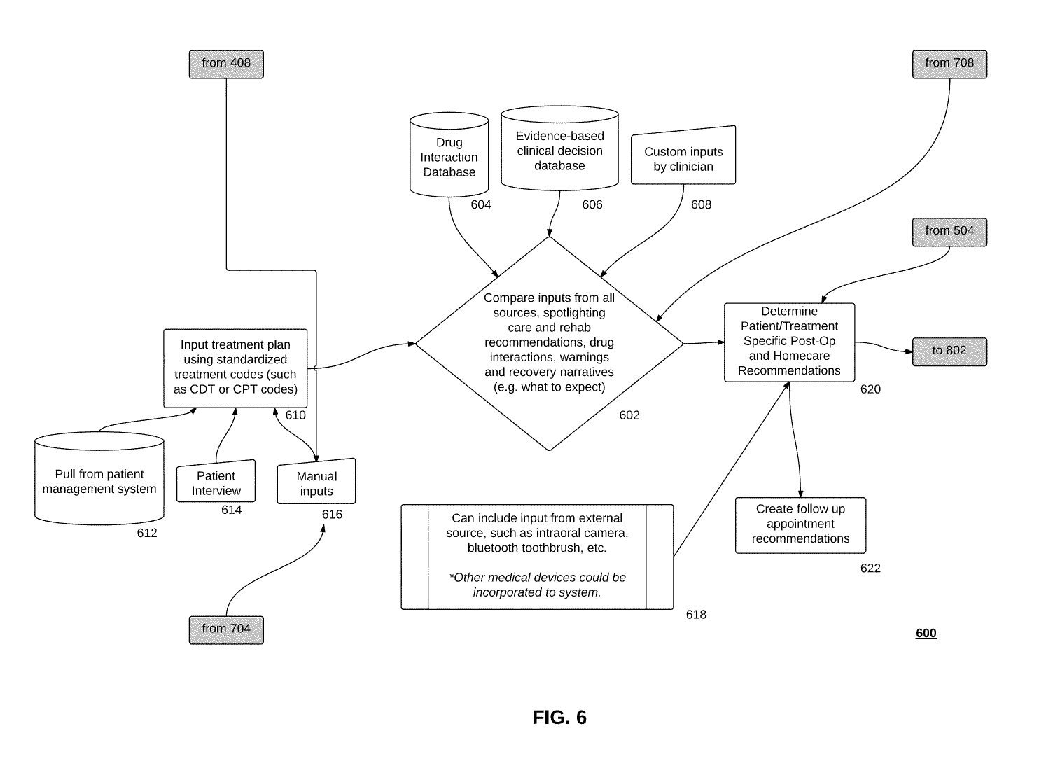

Next, in step 416, the patient may be given the option to follow the recommended treatment or to forego it. If the patient responds in the affirmative, control passes to step 610, which is described with reference to FIG. 6 below, but if in the negative, control passes to step 502, which is described with reference to FIG. 5 below.

Patient Decision Module

FIG. 5 illustrates certain steps performed by patient decision module 500. In an exemplary embodiment, the module determines the best means by which experts, such as clinicians, can communicate with the patient regarding and during post-treatment care.

If the patient agrees to participate in online interaction, then module 500 may establish a table of online notifications for the patient. If the patient prefers offline communications, then module 500 may generate printed documents describing the plan of post-treatment care for the patient to take with them, as well as a means by which the patient may document his or her decisions to not participate in the on-line notification process. The module may also generate reminders to the clinician and their staff regarding off-line post-treatment care follow-up with the patient.

Returning to FIG. 5, following step 416, control passes to step 502, where it is determined whether the patient accepts treatment. If the response is in the negative, control passes to step 508, and the process is ended, but if in the affirmative, control passes to step 504, where offline written documentation may be generated through the module.

Treatment may follow in step 506, and control passes to step 620, as described below in reference to FIG. 6.

Analysis Module

FIG. 6 illustrates certain steps performed by analysis module 600. In exemplary embodiments, the module determines a preferred post-treatment care plan based on relevant factors.

Module 600 may use as input a) the proposed treatment plan (for example, in the cases of dental procedures, as represented by ADA Dental Procedures Codes, b) the patient's medical history (taken from sources including the practice patient management system, information recorded (on manual forms or directly into the PTPCS) by the patient, c) verbal interview with the patient which are then input into the PTPCS, and d) additional input and case treatment notes entered manually by the clinicians, specialists and practice staff. Included in these inputs are the patient's general and specific health risk factors and use of prescription medications.

Module 600 may use these inputs to create a unique patient profile. This profile is algorithmically compared against a set of predefined profiles to determine “best fit”. The degree of closeness of fit is determined for each factor and for the profile as a whole.

This enables the module to identify specific recommendations for post-treatment care. For example, using the above example of dental procedures, if the patient about to undergo oral surgery has a history of rheumatoid arthritis but is not taking an anticoagulant, then the system will identify potential blood clotting as a risk factor, and may suggest 1) testing for thrombin generation before surgery and may suggest 2) that the patient be alert for signs of clotting such as leg pain following the procedure.

This analysis would not normally be conducted in the context of dental care, and represents a higher standard of care than has been the case. Similarly, if the proposed treatment is likely to cause short-term gum sensitivity and possible bleeding, then module 600 may recommend that an intra-oral camera be provided to the patient so that the dentist can visually monitor healing.

As a third example, if the patient has a history of, but no current periodontal disease and the proposed treatment is a routine cleaning, then module 600 may recommend that the patient visually inspect the lower anterior incisors at monthly intervals to determine when to schedule the next cleaning.

Returning to FIG. 6, control and relevant inputs from step 408, as described above, pass to manual inputs step 616, as well as from step 704, as described below. This input, as well as patient interview information, in step 614, and information retrieved from a patient management system 612, may also serve as inputs to step 610. In step 610, these inputs are used to generate a treatment plan, which is input to step 602.

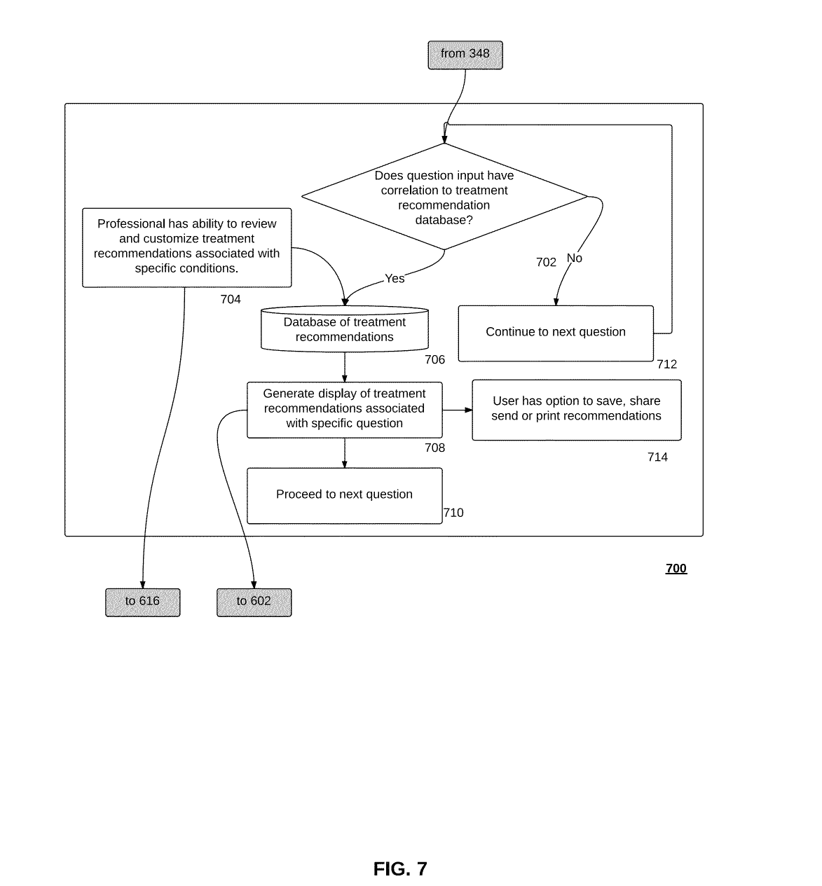

In reference to step 602, additional inputs from a drug interaction database 604, an evidence-based clinical decision database 606 and customs inputs by an expert, such as a clinician, are also input. Additional control and relevant inputs may also be received from step 708, as described below in reference to FIG. 7.

In step 602, one or more of these inputs are compared. Care and rehabilitation recommendations, as well as drug interactions information, warnings and recovery narratives, may be included and spotlighted.

In step 620, the result of the comparison may be used to create a patient profile, with treatment and patient specific parameters, as described above. Homecare recommendations may be included as well.

In step 622, follow-up appointment procedures and recommendations may be pursued after step 620.

Control from step 620 may pass to steps 504, described below in reference to FIG. 5, or step 802, described below in reference to FIG. 8.

Treatment Recommendation Module

FIG. 7 illustrates certain steps performed by treatment recommendation module 400. The module facilitates the ability to store, review and customize patient treatment. In the exemplary steps shown, control and relevant inputs pass from step 348 to step 702. In step 702, it is determined whether the input has a correlation to the treatment recommendation database. If not, control passes to step 712, where the next question is processed, and control is passed back to step 702.

In step 704, the professional, such as the expert, has the ability to review and customize treatment recommendations that are associated with the specific conditions of the patient.

If the response to step 702 is in the affirmative, and following step 704, control passes to step 706, where a database of treatment options is accessed. The control and relevant output from step 704 is also passed to step 616, as described above. Thereafter, in step 708, a display is generated of the treatment recommendations that are associated with the specific question. The control and relevant output from step 708 is also passed to step 602, as described above.

This is followed by step 714, where the user has the option to save, share, send or print recommendations.

After step 708, the next questions are processed in step 710, where the above steps are repeated as required.

Preferred Notification Module

FIG. 8 illustrates certain steps performed by preferred notification module 700. In exemplary embodiments, the module provides a secure (HIPAA-compliant) means by which the clinician can communicate interactively with the patient during the post-treatment care period. This communications may include providing detailed and time-phased instructions to the patient regarding their at-home post-treatment care, and may provide a means by which the patient affirms that they have complied with those instructions.

In an exemplary embodiment, this communications also allows for the clinician to instruct the patient to use various measuring and sensing technologies to collect information which the patient then sends through the modules to the clinician for review. This module also allows for product recommendations to be presented to the patient, should the clinician or algorithm present associated care products appropriate to pre- or post-treatment. If the patient is not fully complying with the instructions, or if the collected data indicates an issue, or if the patient describes an unexpected condition, then the clinician can advise the patient on what should be done, such as for example modifying the post-treatment care, come to the health-care provider's office, and taking other actions.

Returning to FIG. 8, control passes from step 622, as above described, to step 802, where the patient registration is performed. The clinician may register the patient with this module, so that, for example, the system sets the username/password of the patient, and the patient is made to agree to certain terms and conditions for use of the system.

Control passes next to step 804. Notably, control from the above step 334 also passes to step 804.

In step 804, the initial and subsequent aftercare compliance notification is provided. As provided in note 832, the patient may also need to confirm that the notice has been read and that action has been completed, and the patient may be able to determine the manner of the notification, such as for example, via email, text or telephone calls.

Furthermore, as provided in note 834, step 804 relates to a first instance to perform recommended actions, as above noted, and follow-up actions, such as additional notices, can also be provided.

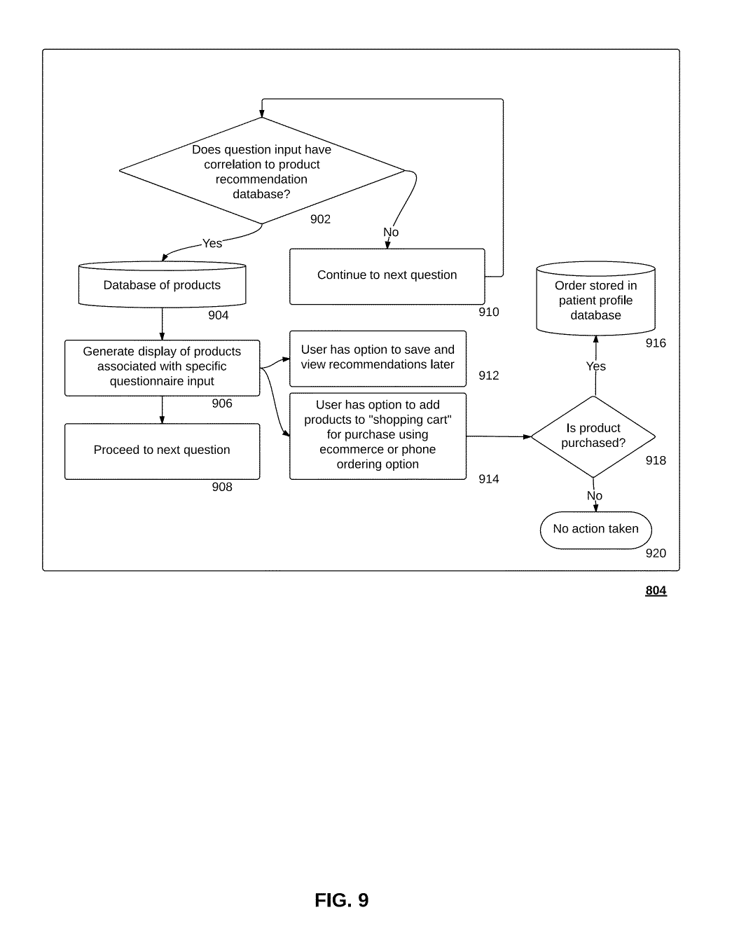

In addition to the foregoing, in an exemplary embodiment, step 804 includes the steps 902-920 as set forth and described in relation to FIG. 9 below.

Next, in step 806, if the patient responds, control passes to step 828, but in the alternative if the patient does not respond, control passes to steps 808, 810.

In reference to step 808, a reminder auto-call, text message, email, or another message may be sent to the patient. In step 810, the clinician may be alerted as well, including by an email, a web portal or any other means.

In step 828, a point by point evaluation of the patient response is performed against the recommendations. Thereafter, in step 830, the clinician may receive notification of the status in step 830.

Next, in step 826, the degree to which compliance has been achieved is determined. Specifically, for example, the compliance score is reviewed. As provided in note 836, the determination may be based on the completion percentage scale of answers to notification questions, and for example, home/after-care instructions.

Next, in step 824, it is determined whether the compliance score is in an acceptable range. If yes, control passes to step 822, where the notification schedule is continued until completion. Alternatively, if the response in step 824 is in the negative, control may pass to step 810, which was described above.

Thereafter, the patient notification may be communicated in any form, such as for example a message 814, a telephone or video conference 816. In addition, the notification may be rescheduled, as shown in step 812, or an office appointment may be scheduled, as shown in step 818.

In step 820, the option may also be provided to remove the patient from the system.

Aftercare Compliance Sub-Module 804

In an exemplary embodiment, aftercare compliance sub-module 804 may implement one or more additional steps in relation to embodiments wherein a purchase of products is made. These steps 902-920 are set forth in FIG. 9.

An Exemplary Implementation of Patient Diagnostic Tools 302 Used in Relation to Patient Diagnostic Questionnaire 304

The embodiments of this section relates to the specific example of dental health care, though the application may be much broader as recognized by skilled persons.

In one non-limiting embodiment, a method is provided for improving communication between dental health professionals and dental patients, the method comprises the steps of: enabling a dental patient to obtain mouth pictures of their own mouth, wherein the mouth pictures can be still pictures and/or video of teeth and gum tissue; displaying the mouth pictures; providing guidance pictures, wherein the guidance pictures depict healthy gum tissue, inflamed gum tissue, and diseased gum tissue; and providing instructions to a dental patient.

The instructions explain how to compare the patient's mouth pictures with the guidance pictures to help the patient determine if they have inflamed and/or diseased gum tissue and therefore should contact a dental practitioner such as, but not limited to, a dentist, a dental hygienist, a referral service for referring dental patients or prospective dental patients to a dental health professional and a dental health professional service, alone or in combination.

The step of enabling a patient to obtain mouth pictures of their own mouth can be facilitated by using any suitable camera such as that described in U.S. Patent Publication Number 20040038169. Another suitable camera is the USB intraoral camera supplied by SEWELL (Part#: SW-29862, hereinafter and purely for convenience referred to as “the SEWELL camera”) which comprises a plurality of LED lights to illuminate the inside of a patient's mouth.

The SEWELL camera can be plugged straight into an Apple Mac computer and photographs displayed on the Mac using, for example, the Mac's proprietary photo application software such as Apple's “Photo Booth.” A close up of the front end of a prior art intra-oral camera reveals a lens and an LED cluster.

The intra-oral camera can be a wireless intra-oral camera such the Sparkdental Dental Wireless Intraoral Camera Sony Super HAD CCD fitted with a plurality of LEDs. The intra-oral camera is optionally fitted with a plurality of UV LEDs (FIG. 10) to detect dental plaque using ultraviolet-induced fluorescence.

The camera preferably has a digital output which can be communicated to a display device. The display device can be a computer such as a personal desk top computer, a laptop or mobile devices such as smart phones and tablet computers. The computer is preferably capable of receiving, either by hardwire via for example a USB port or wirelessly, digital pictures and/or video and displaying the pictures and/or video on a screen. Such devices enable a dental patient to display their mouth pictures. It should be understood that the term “pictures” and “photographs” are regarded as equivalent terms.

The embodiments can be implemented, for example, as an Application stored on a digital device such as, but not limited to, a smart phone. The intra-oral camera communicates mouth pictures to the smart phone wirelessly or via a hard line such as a cord fitted to the intra-oral camera for data transfer to the display device. The display device is used by the patient to display their mouth pictures enabling the patient to compare their mouth pictures against guidance pictures also stored on the display device as part of the Application. The Application could be called “MouthWatch”. The term “MouthWatch” can also be used as a logo to promote the present embodiments.

Alternatively the mouth pictures can be transferred from the camera to a storage device for temporary or permanent storage. Examples of such storage devices are flash drives, hard drives on a personal computer (PC) or stored on an external hard drive operatively coupled to a PC. The mouth pictures can be transferred from the storage device to a display device (such as a smart phone, PC, laptop or tablet computer) for later viewing by the dental patient or the patient's dental practitioner or other dental worker such as a dental hygienist.

The guidance pictures can be hard copy pictures or digital pictures; guidance pictures in the form of digital pictures can be displayed on any device capable of displaying digital pictures such as, but not limited to, a personal desk top computer, a laptop or mobile devices such as smart phones and tablet computers. The purpose of the guidance pictures is to educate dental patients; specifically, to show dental patients what diseased gum tissue looks like, what inflamed gum tissue looks like and what healthy gum tissue looks like. A patient can compare their mouth pictures with the guidance pictures to ascertain if their gum tissue is healthy or possibly diseased or inflamed. Should the patient have questions they can contact a dental health professional to obtain further guidance and perhaps a dental appointment. The patient could also email or otherwise communicate their mouth pictures to a dental professional.

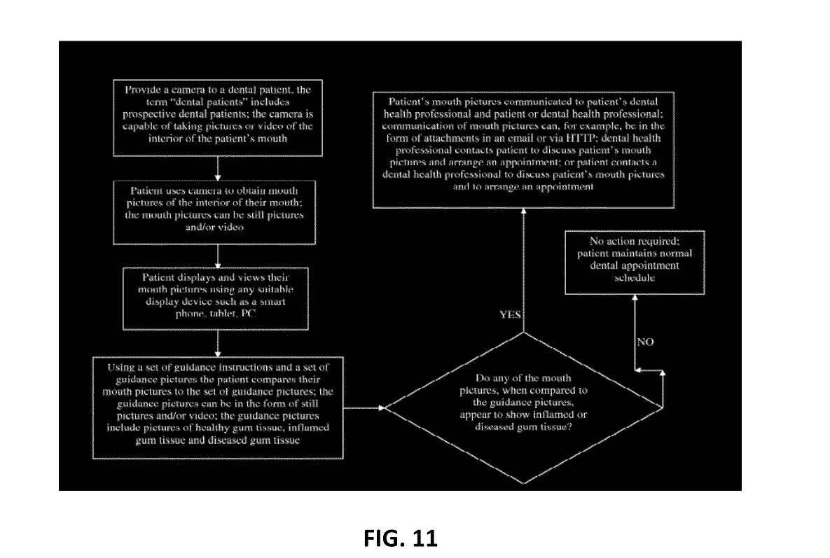

FIG. 11 shows an exemplary flow chart of an embodiment of the present embodiments, which could be run as a smart phone Application 100. In this embodiment a camera communicates mouth pictures to the smart phone which displays the mouth pictures enabling the patient to compare their mouth pictures against guidance pictures which form part of the Application. A set of instructions for the patient can form part of the Application 100.

These exemplary embodiments allows a dental patient to compare the interior of their mouth to guidance photos. Should the patient have questions about their mouth pictures they can contact a dental health professional. Thus, the embodiments improve interaction and communication between dental patients and dental health professionals such as, but not limited to, dentists and dental hygienists.

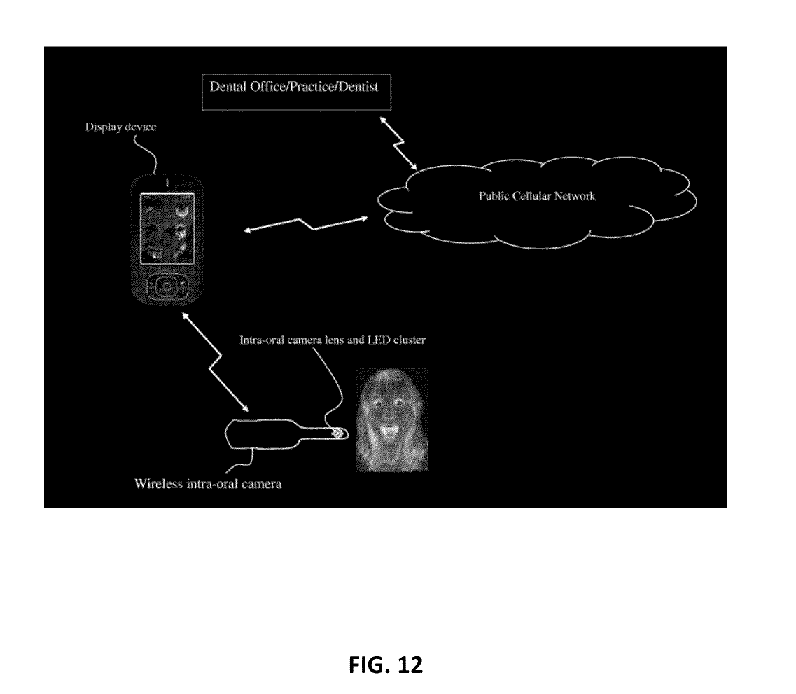

In another embodiment the patient and dental practitioner collaborate in real time (see FIG. 12). The patient inserts an intra-oral camera with wireless communication capability into their oral cavity and proceeds to take pictures of their teeth and gum tissue. The pictures are wirelessly transmitted from the intra-oral camera to a two-way communication device such as a smart phone, preferably set to speaker mode, and the pictures further communicated via the two-way communication device to the patient's dental practitioner in real time via, for example, a public cellular network. Alternatively the intra-oral camera is hard wired connected to the communication device such as a smart phone. The dental practitioner can look at the pictures and observe the state of the patient's teeth and gum tissue. The dental practitioner can then offer professional advice; if appropriate the dental practitioner can advise the patient to visit the dental practitioner's office for further examination or dental work. Since the communication between the dental practitioner and patient is immediate (i.e., in real time) the dental practitioner can also direct the patient to orientate the intra-oral camera at specific parts of the patient's oral cavity such as teeth or gum tissue that the patient may have inadvertently missed and/or not taken pictures thereof.

As discussed above, the intra-oral camera can be fitted with a plurality of LEDs (light emitting diodes) and optionally a plurality of UV LEDs (i.e., LEDs that provide ultraviolet light). An intra-oral camera fitted with a UV LEDs can provide an indication of the degree of whiteness of a patient's teeth. Also, if the intra-oral camera fitted with UV LEDs is used at regular intervals and the pictures communicated to a dental practitioner this can provide feedback on changes to the degree of whiteness, or lack thereof, of the patient's teeth. A dental practitioner can then further advise a patient to visit the dental practitioner's office for a teeth whitening procedure. In the alternative, pictures obtained with UV LEDs can be communicated to a device such as a laptop, smart phone or PC and the pictures taken at different times compared by the patient with a reference chart to monitor the whiteness of the patient's teeth.

In the alternative, the dental practitioner can view the patients mouth in real time from a remote location such as, but not limited to, their dental office. This can be achieved, for example, by the patient taking digital pictures of their teeth using an intra-oral camera fitted with a plurality of UV LEDs and communicating the digital pictures via a cellular network to a dental practitioner who can interpret the pictures and advise the patient on the whitening status of the patient's teeth.

In yet another embodiment a first medical professional such as a paramedic inserts an intra-oral camera with wireless communication capability into the mouth of a patient that has sustained possible trauma to their oral cavity, perhaps because of a road accident. The first medical professional captures pictures which are wirelessly transmitted to a display device such as a smart phone and the pictures further communicated to a second medical professional such as an on-call dental practitioner or surgeon in real time. The second professional can look at the pictures in real time and observe the state of the interior of the patient's mouth and communicate medical advice in real time to the first medical professional.

A specific implementation of the above is via a product innovation, as described in detail below.

Specifically, a MouthWatch™ innovation provides as follows. The innovation enables a consumer patient to inspect his or her own entire oral cavity, to independently evaluate his or her own oral health/dental condition, to securely provide images to a dental professional, and to allow a dental professional to remotely examine their mouth. Exemplary embodiments are as follows.

These embodiments are specifically designed to overcome problems that have inhibited consumers' effort to obtain convenient, inexpensive professional dental consultation in that it is not necessary for the dentist and the patient to be co-located in order for them to have access to visual access to dental professionals.

While the embodiments incorporate a CMOS camera and USB technologies and Internet communication, they add a unique structured process to integrate hardware and software to facilitate user-guided remote dental consultation.

Main components of camera: In an exemplary embodiment, the MouthWatch™ product innovation produces an intra-oral camera that connects to the MouthWatch™ software via a computer and USB connection, and also via other known technologies. In an exemplary embodiment, this is the primary device used by the end-user for capturing images and video. The camera will include LED lighting, and zoom and image-capture buttons. Additional input sources to the software will be accepted including alternative video and still image sources (webcam, cell phone, SD card and the like). In addition, the camera may communicate in a variety of methods, including wirelessly by Bluetooth, by RF and other known technologies. Additional technologies include, without limitation, by pedometer; by food journal; and by blood pressure monitor.

Main steps of the remote exam system: Patient conducts self-examination with MouthWatch™ software and video device, outside of dental facility-using integrated reference images, audio, video and animations to guide the examination, performed limited so-diagnosis, store/save the exam images locally or in the cloud.

Patient can then compare these images with the reference library of dental images, information and tools that enable self-diagnosis and comparison to previous examinations. For example, a patient might look up what a healthy gum line looks like next to a tooth and then compare with their own tooth and gum line. During an exam the following month, they can compare the current and previous exams to see if gum recession has occurred.

The patient has the ability to securely share exam image captures, comments and questions with her own dentist or a network of dental providers to seek professional advice or determine if an in-office visit is required. Full functionality allows for the patient to manage their appointment, recall schedule and more in communication with the dental office.

The above may occur either in a turn-based environment, where a patient uploads the information and then the dentist is notified that they have a patient's MouthWatch™ exam to review. Once reviewed, it sends a notification back to the patient/consumer.

In another embodiment, a streaming system is provided wherein the dentist can see a live video feed of the examination that is being conducted by the patient or a care provider. The dentist or the patient are able to immediately advise the patient or caregiver, and can capture still images, videos, recordings or other details in this type of exam for future reference.

Additional functionality allows for the user to quickly have their concerns and exam images sent to a number of dental professionals in order to get multiple opinions more easily than having to physically visit numerous dentist.

In summary, the MouthWatch™ innovations provide for self-exam that remains on the user's computer and is compared to reference images or prior exam images and/or videos; and communication with dental health professionals of images/video captured during home examination is provided, including a turn based method, or a streaming video/audio method as noted.

Main components of plaque checker function: A camera incorporates both White light and UV lights UV light LEDs surrounding the camera lens at the distal end of the camera handpiece.

The user or remote dentist (in streaming exam mode) is able to enable these UV lights in a fashion either through the use of the software or through a physical switch on the actual handpiece.

The patient may or may not need to use a liquid florescent treatment in order to reveal the plaque.

The patient will be able to capture the entire exam similarly to a regular exam, with stills and video of the entire oral activity.

The plaque tracking feature, with the aid of visual guides in the software, directs the user to capture images of specific teeth.

These images can be used in future examinations to serve as a reference point to compare improvements in plaque levels due to brushing.

In an exemplary embodiment, this feature uses the addition of a colored plastic housing attached to cover the distal end of the handpiece in order to have the light be a certain shade.

Main component of whitening tracker: The designed software incorporates a mode where the user will capture images of certain teeth.

In an exemplary embodiment, the user is then be directed to select several spots on the tooth which will then be averaged and assign a color value.

This color value is used against future references of a color average to determine either a percentage increase in whitening or some other scale of whitening.

The tooth whitening shade can also be selected from an image of a range of shades, and the user can periodically check their shade against the reference guide.

In an exemplary embodiment, the user will also receive messages reminding him or her to check the whiteness of his or her teeth. This function is integrated with a sales feature to provide recommended whitening products based on the whitening goals of the patient, as a customer.

Machine Instructions Environment

In one or more embodiments, the steps of the present embodiments are embodied in machine-executable instructions. The instructions can be used to cause a processing device, for example a general-purpose or special purpose processor, which is programmed with the instructions, to perform the steps of the present embodiments.

For example, the present embodiments can be provided as a computer program product. In this environment, the embodiments can include a machine-readable medium having instructions stored on it. The instructions can be used to program any processor (or other electronic devices) to perform a process according to the present embodiments.

In addition, the present embodiments can also be downloaded as a computer program product. Here, the program can be transferred from a remote computer (e.g., a server) to a requesting computer (e.g., a client) by way of data signals embodied in a carrier wave or other propagation medium via a communication link (e.g., a modem or network connection).

The present embodiments can be implemented using computer programs (i.e., “software,” or “computer control logic”) running on Processor 204. The software can be originally stored as a “computer program product” on removable storage device 218 or hard disk drive 212. Therefore, computer program product refers to means for providing software to computer system 106.

In another embodiment, implementation is primarily in firmware and/or hardware using, for example, hardware components such as application specific integrated circuits (ASICs). Implementation of a hardware state machine so as to perform the functions described herein will be apparent to persons skilled in the relevant arts.

Certain Explanatory Conclusions

As referenced hereinabove, “exemplary embodiment(s),” “one embodiment,” “an embodiment,” or similar language means that a particular feature, structure, or characteristic described in connection with the embodiment is included in at least one embodiment described in the specification. Accordingly, appearances of the phrases “exemplary embodiment(s),” “in one embodiment,” “in an embodiment,” and similar language throughout this specification may, but do not necessarily, all refer to the same embodiment.

Additionally, the described features, structures, or characteristics of the described embodiments may be combined in any suitable manner in one or more embodiments. In the foregoing description, numerous specific details are provided, such as examples of hardware, software, programming, networking, databases, modules, user interfaces, among many others, to provide a complete understanding of the embodiments. Persons skilled in the relevant art(s) will recognize, however, that these embodiments may be practiced without one or more of the specific details, or with other methods, components, materials, and the like. In certain instances, well known structures, materials, or operations are not described or illustrated in detail to avoid obscuring certain aspects of the embodiments and in view of one skilled in the relevant art(s).

Certain schematic flow chart diagrams are included herein, and are generally set forth as logical flow chart diagrams. It should be noted that as such, the depicted order and labeled operations herein are indicative of one or more exemplary embodiments of certain presented methods. Other operations and methods can be conceived by skilled persons that are equivalent in function, logic, or effect to one or more operations, or portions thereof, of the illustrated methods. Also, the format and symbols used are provided to explain the logical operations of these methods and are not to limit the scope of the methods. Although various connectors, lines and arrow types can be employed in the flow chart diagrams, they are not to limit the scope of the corresponding methods. Indeed, some of such connectors can be used to indicate only the logical flow of these methods. Additionally, the order in which a particular method occurs may or may not strictly adhere to the order of the corresponding operations shown.

Although the operations of the methods herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Lastly, while various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A method for effecting a post-treatment compliance for a medical patient, the method being performed by a system comprising:
a memory operable to retain a series of instructions; and
a processor operable to retrieve and execute said instructions to perform a series of steps, the steps comprising:
receiving as a first input any one of: information from a patient management system regarding the patient; information from a patient interview conducted with the patient; and information from one or more manual inputs;
generating a patient treatment plan based on said first input;
receiving as a second input any one of: a drug interaction based information; an evidence-based clinical decision information; and a custom clinical input information;
receiving as a third input a treatment recommendation process;
comparing the inputs of any two or more of said first input, said second input and said second input;
determining a post-treatment recommendation specific to the patient for the patient based on the comparison; and
effecting the post-treatment patient compliance via a patient notification process.

2. A method according the claim 1, wherein the effecting step comprises:
providing as an output to the patient the post-treatment recommendation; and
monitoring via inputs from the patient whether the patient is in compliance with the post-treatment recommendation.

3. A method according the claim 2, wherein the effecting step further comprises:
notifying a clinician whether the patient is in compliance with the post-treatment recommendation.

4. A method according to claim 1, wherein the patient treatment plan employs a standardized treatment code.

5. A method according to claim 1, wherein the determination includes information input from an external source.

6. A method according to claim 5, wherein the external source comprises any one of: an intraoral camera; a Bluetooth™ toothbrush; a pedometer; a food journal; and a blood pressure monitor.

7. A method according to claim 1, wherein the patient treatment plan is based on a synthesized clinician information being based on any one of: input about the patient retrieved from one or more telehealth tools; responses of the patient to one or more questionnaires; and responses of the patient provided by the patient upon one or more in-office visits.

8. A method according to claim 1, wherein the determination is additionally based on a professionally rendered treatment recommendation.

9. A system for effecting a post-treatment compliance for a medical patient comprises a memory operable to retain a series of instructions, and a processor operable to retrieve and execute said instructions to perform a series of steps, the system comprising:
means for receiving as a first input any one of: information from a patient management system regarding the patient; information from a patient interview conducted with the patient; and information from one or more manual inputs;
means for generating a patient treatment plan based on said first input;
means for receiving as a second input any one of: a drug interaction based information; an evidence-based clinical decision information; and a custom clinical input information;
means for receiving as a third input a treatment recommendation process; and
comparing the inputs of any two or more of said first input, said second input and said second input;
means for determining a post-treatment recommendation specific to the patient for the patient based on the comparison; and
means for effecting the post-treatment patient compliance via a patient notification process.

10. A system according the claim 1, wherein the effecting means comprises:
means for providing as an output to the patient the post-treatment recommendation; and
means for monitoring via inputs from the patient whether the patient is in compliance with the post-treatment recommendation.

11. A system according the claim 10, wherein the effecting means further comprises:
means for notifying a clinician whether the patient is in compliance with the post-treatment recommendation.

12. A system according to claim 1, wherein the patient treatment plan employs a standardized treatment code.

13. A system according to claim 1, wherein the determination includes information input from an external source.

14. A system according to claim 13, wherein the external source comprises any one of: an intraoral camera; a Bluetooth™ toothbrush; a pedometer; a food journal; and a blood pressure monitor.

15. A system according to claim 1, wherein the patient treatment plan is based on a synthesized clinician information being based on any one of: input about the patient retrieved from one or more telehealth tools; responses of the patient to one or more questionnaires; and responses of the patient provided by the patient upon one or more in-office visits.

16. A system according to claim 1, wherein the determination is additionally based on a professionally rendered treatment recommendation.
